(19) United States
(12) Patent Application Publication
(10) Pub. No.: US 2007/0000216 A1
(43) Pub. Date: Jan. 4, 2007

(54) Method and apparatus for evaluating animals' health and performance

(76) Inventors: Stanley Ben Kater, Park City, UT (US); William B. Rottenberg, Durango, CO (US)

Correspondence Address: GOTTLIEB RACKMAN & REISMAN PC, 270 MADISON AVENUE, 8TH FLOOR, NEW YORK, NY, 100160601, US

(21) Appl. No.: 11/156,832

(22) Filed: Jun. 20, 2005

Related U.S. Application Data
(60) Provisional application No. 60/581,818, filed on Jun. 21, 2004.

(51) Int. Cl. A01K 29/00

(52) U.S. Cl. 54/1

(57) ABSTRACT

A low cost animal health diagnostic, performance and evaluation apparatus and method includes one or more sensors measuring the gait of the animal (such as a horse), signals associated with the impact of each limb on the ground and physical movement during all phases of the horse's gait. A controller unit receives the data from the sensor(s), analyzes the data and generates an indication or diagnostic data regarding the animal. Said diagnostics are designed for quick and reliable field acquisition.

### RELATED APPLICATIONS

This application claims priority to U.S. provisional application Ser. No. 60/581,818 filed Jun. 21, 2004 and incorporated herein by reference.

### BACKGROUND OF THE INVENTION

A. Field of Invention

This invention pertains to a method and apparatus for evaluating or diagnosing the performance, health or condition of an animal, such as a horse, and more particularly, a method and apparatus that includes a sensor attached to the animal's hoof or limb and electronic analyzer receiving signals from the sensor as the animal is in motion and generating a signal indicative of a condition of the animal.

B. Description of the Prior Art

Animals, and especially, horses are used for various purposes including performance and recreational activities. The precise way in which an animal moves is indicative of his performance and health. Poor performance or lameness must be detected as early as possible to insure that any problems are addressed promptly. This may involve rest, treatment or training, as appropriate.

While these concerns are applicable to horses used in all kind of activities, they are particularly important for all performance horses, such as dressage, racing, or other competitive events. The specific character of movement of a horse determines the utility of that animal, and the quality of movement essentially defines the value of the animal. Pathological problems in movement, such as lameness, can render an animal completely unfit. This is particularly true in horses, where lameness may occur in over 10% of all animals, causing annual losses exceeding $1 billion due to the loss of use, associated costs, and treatment. An owner's lack of awareness of the state and nature of an animal's lameness or performance can result in losing that animal's ability to perform its designated tasks. Hence, undiagnosed lameness is a major economic drain on the equine industry. Early awareness of lameness or poor performance can result in remediation of the problem and restoring an animal rapidly to full function.

The vast majority of evaluations of equine gait function and dysfunction are made by qualitative determinations by individuals, such as veterinarians and trainers, because it is more practical to make the determination in the field, shortly after the injury, avoiding the need to transport the animal. Attempts have been made to provide quantitative analysis of the function and dysfunction of equine movement by measuring elements of the gait, including ground reaction force and timing between hoof strikes. In these methods, the elements of the gait are measured using video analysis, impact force measurement, or other means. Impact, or ground reaction force is measured by a force plate installed on the ground or by mounting special shoes or boots with impact sensors on the strike surface on an animal's feet. Video analysis can also be employed to examine the relationship of limbs and their components relative to one another. Additionally, accelerometers mounted on the horses' limbs can provide information on motion. However, a significant drawback of these methods is that they are time-intensive, requiring complex instrumentation and skilled technicians to perform diagnostics. This problem essentially confines these methods to research laboratories and large animal hospitals and are not readily useable in the field.

Other disadvantages of the existing methods include the major limitation of requiring significant planning and set up time and the necessity of transporting the animal to the properly equipped laboratory or animal hospital. Two more disadvantages specific to using shoes or boots with impact sensors are that, first, this method requires hoof-size specific shoes or boots for every animal and, second, the shoes or boots add mass to the most distal portion of the limb, which alters the nature of the gait.

### SUMMARY OF THE INVENTION

An apparatus for determining the health and performance of an animal, such as a horse, includes a sensor associated with at least one of the feet of the animal and a control unit. The sensor detects signals from one or more of the animal's hooves or limb bones that are associated with the animal moving, or running. These signals are then conditioned so that they are suitable for processing and stored. The control unit then processes the signals, for example, by comparing them to standard and reference signals. An output is then generated that indicates the performance status of the horse.

In one aspect of the invention, an algorithm is used that takes one of three approaches. All approaches make use of acquired data that provide a threshold or reference level to which the algorithm compares performance. In the first approach, a historical database of a series of footsteps can be acquired initially from the same animal when it is sound and thus serve as a reference for the algorithm evaluating subsequent performance. The data could be collected during an initial pre-purchase exam, for example, to establish standard documentation. Using self-reference eliminates problems associated with establishing a “normal” gait for horses by allowing each specific animal to establish its own reference. For a historic reference, a database would be built with the horse in gait under conditions common for future studies.

In the second approach, alternatively or in addition to historical referencing from the animal, the state of lameness in one limb can be referenced to the data acquired from other limbs of the same animal at the same time.

In a third approach, data acquired from one animal is referenced from a library of data acquired from many animals.

### BRIEF DESCRIPTION OF THE FIGURES

The features, aspects and advantages of the invention will become further understood with reference to the following drawings and description where:

FIG. 1 is a view of an animal health diagnostic and performance evaluation system constructed in accordance with this invention, with a controller unit located on the animal and connected to the sensor or sensors by wires;

FIG. 2 is a view of an animal health diagnostic and performance evaluation system with the controller unit located remote from the animal and communicating to the sensor or sensors wirelessly;

FIG. 3 shows an enlarged view of a horse's hoof with one or more sensors the animal health diagnostic and performance evaluation system of FIG. 1 or FIG. 2;

FIG. 4 is a basic diagram of a sensor unit for the animal health diagnostic and performance evaluation system of FIG. 1 or FIG. 2;

FIG. 5 is a block diagram of the invention illustrated in FIG. 1;

FIGS. 6a-6d show the four phases of a typical step by a horse;

FIGS. 7a-7d show four outputs from the sensor of FIG. 1 corresponding to the four phases of FIGS. 6a-d;

FIGS. 8a and 8b show a first and a second set of traces obtained from the sensor of FIG. 1 for the same horse two months apart;

FIGS. 9a and 9b show respectively a complete trace and an enlarged trace section for a sound horse;

FIGS. 9c and 9d show respectively a complete trace and an enlarged trace section for the horse of FIGS. 9a, 9b with left rear leg lamed;

FIG. 10 shows an example for the system used in performance evaluation, including the transition in gait from a trot (circled) to a walk (line).

FIG. 11 shows a plot representation of a horse's gait;

FIG. 12 shows the plot of FIG. 11 with data indicative of a lame horse, the reference leg RF(A1) and a lame LR (A2)

FIG. 13 shows a block diagram illustrating the data collection for a single horse leg; and

FIG. 14 shows a block diagram illustrating the data collection for all the legs of a horse.

### DETAILED DESCRIPTION OF THE PREFERRED EMBODIMENT

The present invention is directed to an improved system, sensor and method of diagnosing animal health and performance. The assessment of health and performance can be done for many purposes, including, but not limited to, pre-purchase exams, evaluation of the quality of the normal gait, evaluation of deviation from the normal gait, and assessment of lameness or disease. Additional illustrative uses include assessing other gait-changing factors: footing, shoeing performance by type/shape/size/material, genetic predisposition to performance, dominance of breeding parents, rate of injury healing, natural ability, performance measurement capability (including improvement or deterioration), effect of equipment such as saddle/harness/bit, effect of rider/driver, performance standards for insurance and effect of pharmaceuticals/diet/dietary supplements/rehabilitation routines.

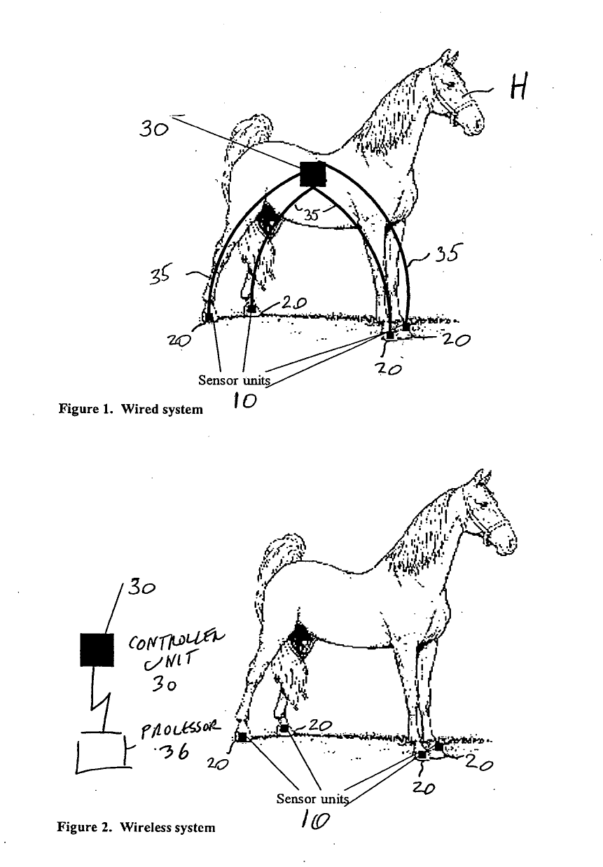

FIG. 1 shows a first embodiment of the invention. One or more ultra low mass sensor units 10 are attached to the external surface of each hoofwall 20 of horse H. The controller unit has its own power source (not shown) and is mounted on the horse as well. Each sensor communicates with the controller unit 30 by wires 35. The wires may be dressed so that they do not interfere with the movement of the horse H. The sensor unit 10 detects data and transmits it to the controller unit 30. The data collected by the controller unit 30 may be analyzed in situ or stored in a memory for later analysis, as described in more detail below.

In one alternate embodiment, the sensor unit 10 communicates with the controller unit 30 wirelessly, in which case the wires 35 are omitted. In another embodiment, shown in FIG. 2, one or more sensor units 10 are mounted on the hooves (or limbs) 20 and the controller unit is disposed at a monitoring station disposed in the area. Communication between the controller unit 30 and the sensor units 10 is, in this case, wireless. Moreover, the controller unit 30 may exchange data with a remote processor unit 36 through standard communication channels, as described in more details below.

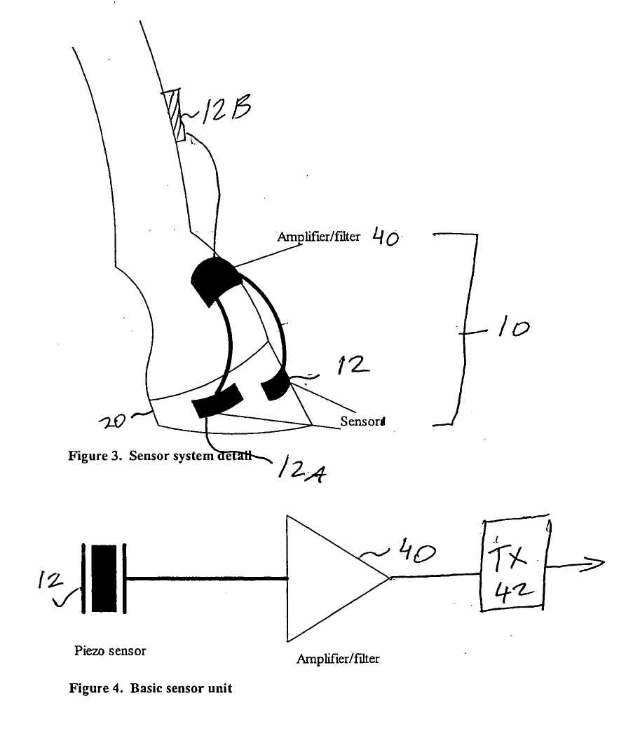

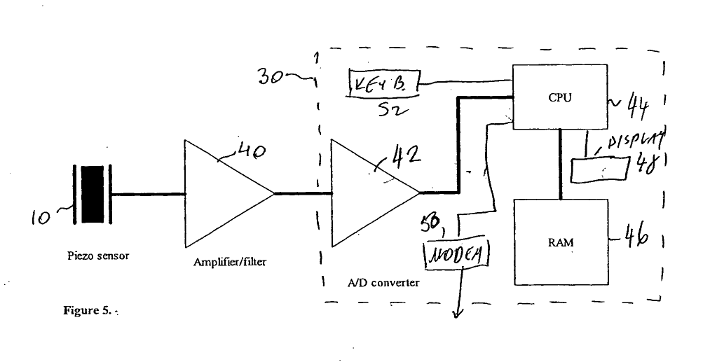

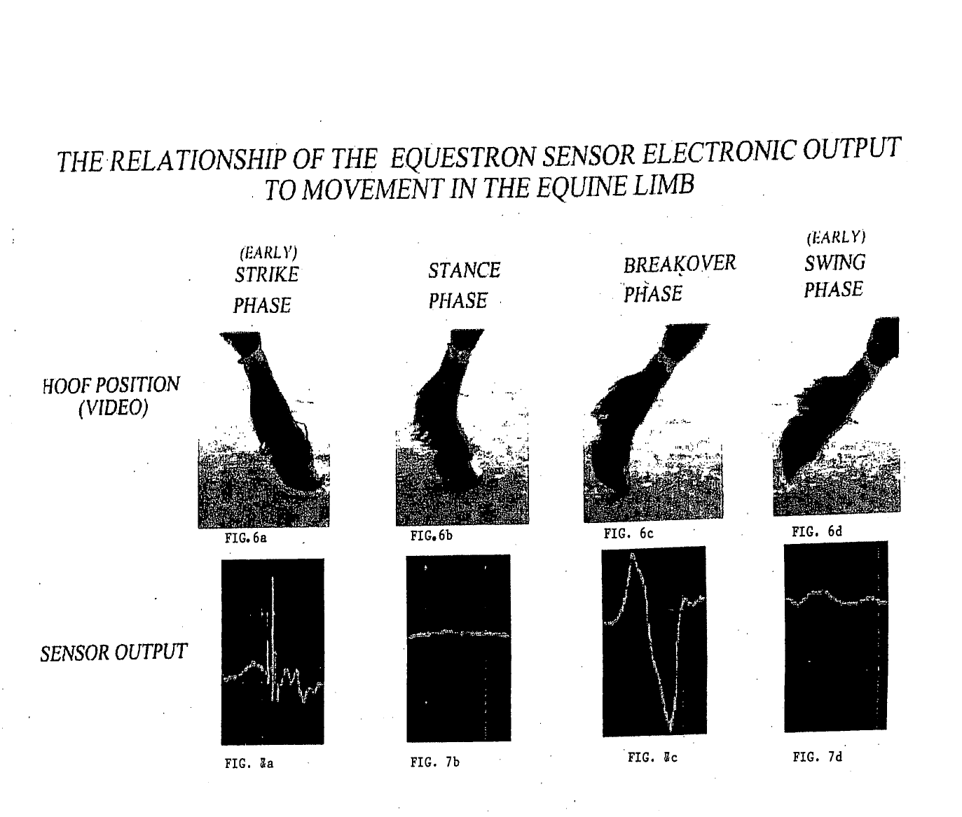

Turning now to FIG. 3, each sensor unit 10 may consist of one or more components, depending on whether it is wired directly to the controller unit or is in wireless communication therewith. The sensor unit 10 includes a sensor element 12 attached to a non-impact surface of a hoof, and preferably to the surface of a front lateral wall of the hoof, as shown. The sensor unit 10 may also include another sensor element 12A placed on other lateral walls of the hoof or a sensor element 12B attached in apposition to some of the limb bones of the horse, such as the cannon bone. In most instances a single sensor per leg is sufficient. Preferably, the sensor element 12 is a ultra, light weight piezoelectric film, such as that provided by Measurement Specialties, Inc. (Fairfield, N.J.) arranged and constructed to measure instantaneous mechanical activity (stress, vibration, temperature, acceleration) and to generate electrical signals indicative of said data. Other types of sensors may be used as well. For the embodiment of FIG. 1, the sensor element 12 is connected directly to the controller unit 30 by wires 35. Otherwise the signals from the sensor element 12 are processed by the sensor unit 10 as discussed below.

Preferably, sensor element 12 is attached to the hoof (or bone) via an adhesive layer, a soluble adhesive, an adhesive film or other similar means that allows for fast attachment and removal of the sensor element 12, preferably without cosmetically damaging the hoof. For example, the sensor element is attached to the hoof by double-sided adhesive tape (not shown). The hoof surface should be cleaned of residue and be sufficiently smooth to allow the sensor to acquire and maintain uniform contact to the exterior wall surface of the hoof. The surface of the exterior wall of the hoof can be treated to improve the uniformity and smoothness of sensor contact area. Mechanical means of attaching the sensor unit may be used as well.

As discussed above, in one embodiment shown in FIG. 1, the controller unit 30 is located on the animal and communicates through a wired or wireless communication channel with the sensor unit(s) 10. The controller unit 30 is attached to one of the hooves 20 with the same adhesive means as the sensor unit 10. Alternatively, the controller unit is attached above fetlock joint by using a band or strap, to the lower leg by using a band, a strap, or an under-the-leg wrap.

In another embodiment shown in FIG. 2 the controller unit 30 can be located off the animal, gathering the data from the sensor as shown in FIG. 2.

As shown in FIG. 4, if the sensor unit 10 is not wired directly to the controller unit 30, then the output of sensor element 12 is connected to an amplifier/filter 40 which conditions the signal from the sensor by removing noise and amplifying it. The output of the amplifier 40 is then sent to the controller unit 30 via the transmitter 42, using radio frequency (RF), BlueTooth, WiFi, or optical transmissions.

Referring to FIG. 5, the controller unit 30 includes an amplifier 42 which conditions and filters the signals from the sensor unit(s), and, if necessary, may include an A/D converter as well. The output of the amplifier 42 is fed to a CPU 44. The controller 40 also includes one or more memory modules such as RAM 46 used to hold programs for the CPU 44 and for data logging. Optionally, the controller unit 30 also includes a display 48, a communication device, such as a modem 50 and a data and command entry device such as a keyboard 52. The apparatus shown in FIG. 5 is used to obtain information about animals, such as horses and to generate reports on their health and performance.

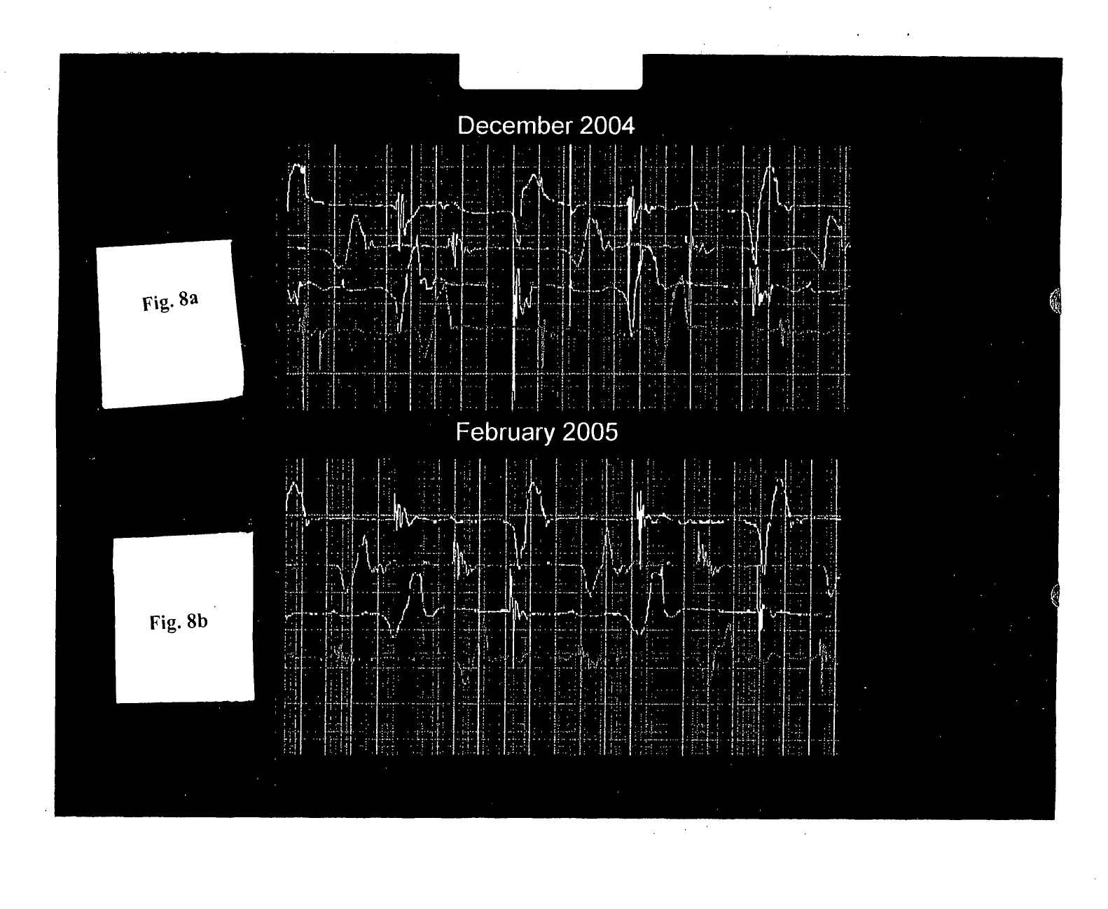

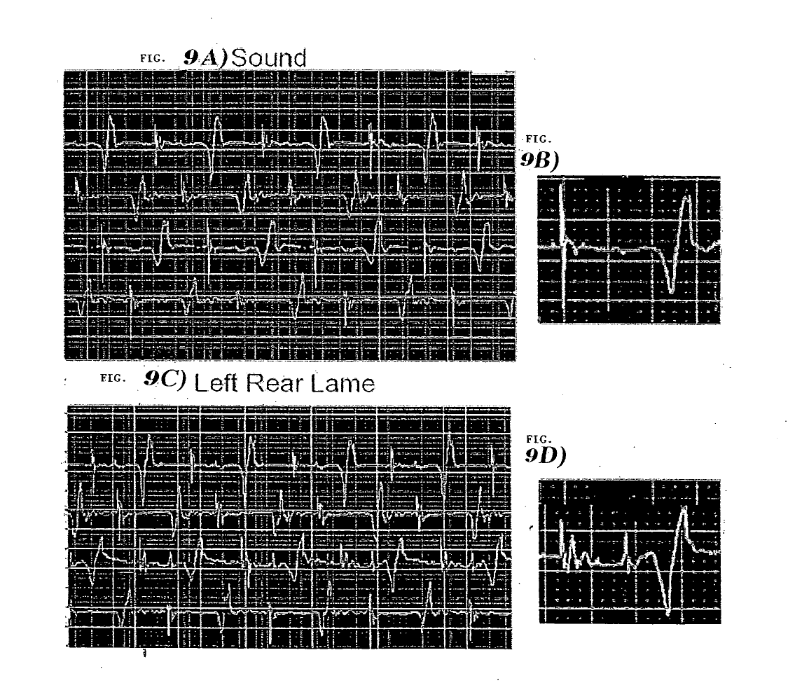

Generally speaking, as the horse H is involved in various physical movements (such as walking, running, galloping, etc.) the sensor elements detect instantanous mechanical changes and generates corresponding sensor signals. In this manner, the sensor units detect the signatures of the mechanical energies and forces channeled through the non-impact surface of a hoof or hooves of an animal. These forces and energies result from ground interactions, particularly impact, toe break-over, dragging, swinging and scraping the hoof against the ground. The sensor is omni-directional, and it integrates information about mechanical changes using the hoof as a conduit of the changes. More particularly, as the horse takes a step, the contact between a hoof and ground occurs in four stages, generally referred to as strike, stance, breakover and swing. Each of these phases produce forces in the animal hoof and limb bones that are sensed in the present invention and recorded. FIGS. 7a-d show the characteristic signals generated by the sensors during each of these phases. FIG. 8a shows a typical trace obtained for a moving horse. The trace consists of four segments, the segments corresponding to the outputs from the sensors associated with the following legs, in sequence, starting from the top: RR (right rear), RF (right front), LR (left rear), LF (left front). Looking at these traces, one can easily recognize the four distinct phases shown in FIGS. 7a-d. Importantly, FIG. 8b shows a trace similar to the trace in FIG. 8a. The two traces were taken from the same horse, the trace of FIG. 8b was taken about two months later. The two traces are very similar indicating the approach taken in the present invention yields consistent results over time.

FIGS. 9a, 9b and 9c, 9d again show respective traces for a moving horse. However in FIGS. 9a, 9b the horse is sound while in FIGS. 9c, 9d the left rear leg is lame. (This was accomplished by temporarily disabling the horse by taping a small machine nut against the sole of the hoof)

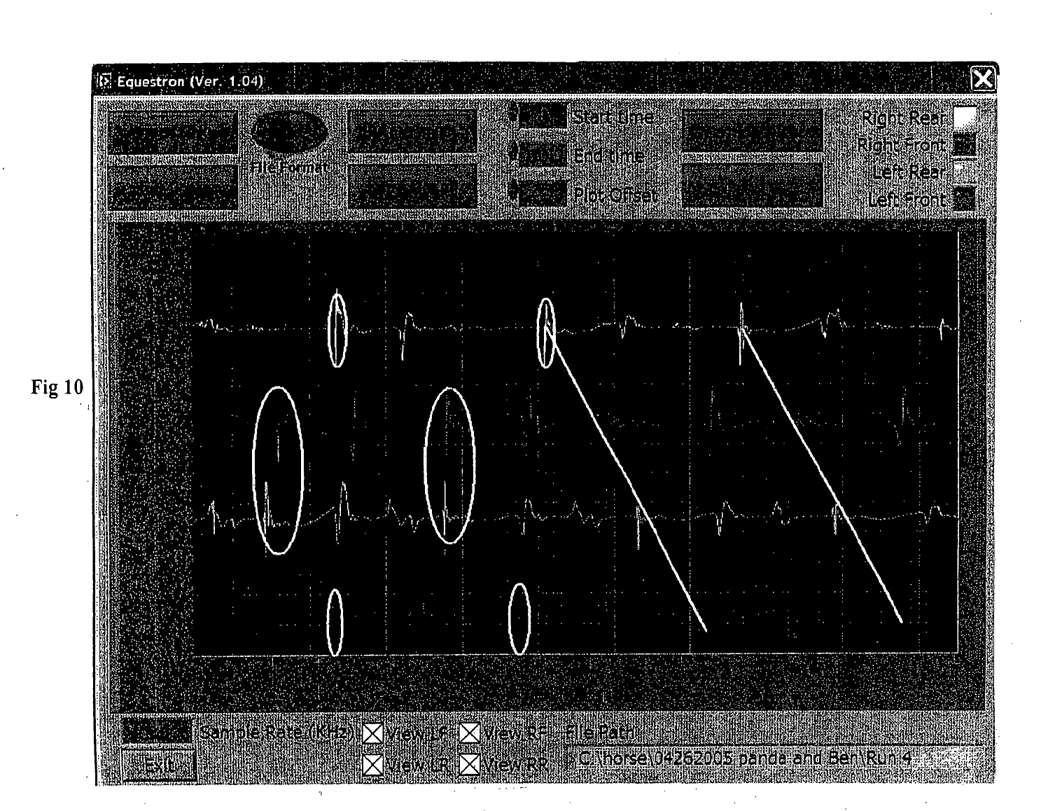

The trace obtained from a horse can be analyzed visually and/or automatically. For example, as shown in FIG. 10, the same phase from each leg can be identified and lines can be added for illustration. In the figure, the lines on the right are used to join the strike phase from legs RR, RF, LR and LF. The strike phases are aligned indicating a walk. Another way to analyze the trace is to compare the relative positions of the phases. For example, in the trace of the Figure, as indicated by the two large ovals, the strike phase for legs RF and LR almost coincide, indicating a trot.

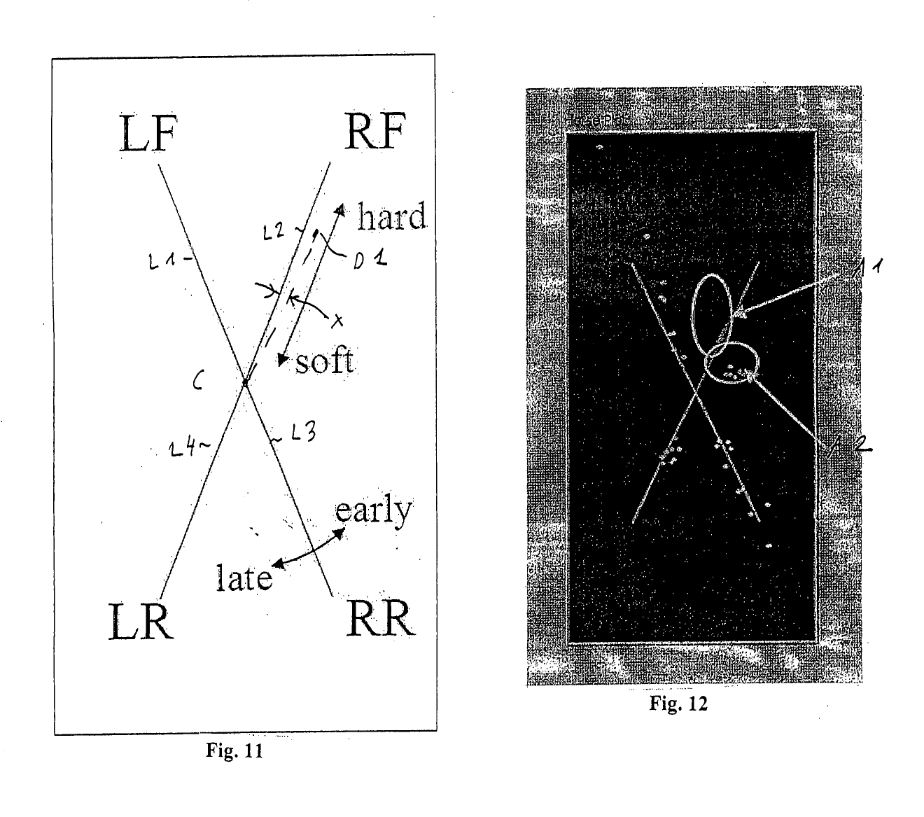

FIG. 11 shows a plot that is used as an alternative means for illustrating the signals obtained from a horse. In this Figure, four diagonal axes L1, L2, L3 and L4 emanate from a center or origin C. Each of axis corresponds to one of the legs as shown. Data obtained from the sensors are indicated as dots, such as D1 on the plot. The radial distance of the dot from the center C is proportional to the amplitude of a respective step phase, such as the strike. A shorter distance is indicative of a softer step then a longer distance. The angle of deviation x from the respective axis indicates that the respective phase (e.g., the strike) is either late or early. FIG. 12 shows a plot of a lame horse. The dots in area A1 indicate the reference leg (RF), while dots area A2 show data indicating a lameness in the LR.

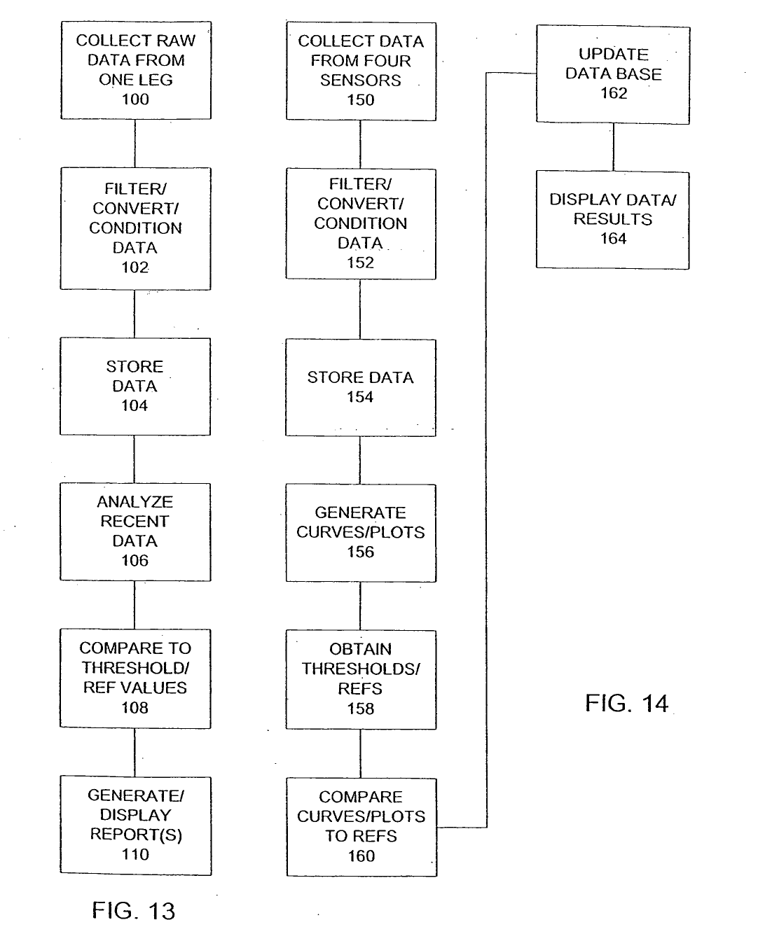

Referring now to FIG. 13, the controller unit 30 can operate in a number of different modes. In one mode, it analyses the data and uses one or more characteristics of an animal's footstep obtained from a single sensor (e.g., a sensor disposed on a single hoof). This approach may be desirable for example, when it is already known or suspected that a particular horse has a problem with that particular foot. Referring to FIG. 13, in step 13 the controller unit collects the raw data. In step 102 the data is filtered/conditioned/converted and generally processed so that it is in a form in which can be easily stored and subjected to further processing. In step 104 the data is stored in RAM 46. In step 106 the data recently stored is analyzed. As part of this analyses the data characterizing the gait of the horse, including the four curves shown in FIGS. 7a-7d are reviewed including the timing of and between the specific curves, maximum/minimum curve amplitude, the power and frequency response, the duration and characteristics of the various footstep intervals, the intervals between various components of the footsteps. The characteristics recognized and used by the controller may also include the initial impact of the hoof, the duration of contact between the hoof and the ground, rollover of the toe (which is gait-specific and characteristic of individual movement), scraping the hoof along the ground, and dragging of the hoof as it is lifted in order to determine whether some or all of these characteristics are nominal, or indicative of a problem. In step 108 the controller unit compares them to standard threshold or reference values. As part of this step, instead of comparing specific values, such as duration, amplitude, etc., a curve matching algorithm may be used as well.

These values are stored in the RAM 46 and could be obtained in a number of ways. One way is to have the specific horse tested while it is sound and collect these desired information so that it could be used later. Another way is to collect information from other legs of the horse. Yet another way is to obtain information from one or more other horses that preferably share some characteristics as the horse being tested and store this information, including information from similar animal specimens (by breed, size, age, purpose, blood relatives), and potential correlations (athletic predisposition, diseased, injured, debilitated) Yet another way is to analyze a number of horses that could be either the same type, or of different type, and accumulate statistical data, including average and RMS deviations for specific characteristics. Other ways of obtaining threshold or reference values may be used as well.

Once the analysis phase is completed, in step 110 the results are shown, for example on a display 48. The analysis can be done locally or the raw data can be transmitted to a central processing station by modem 50.

As indicated in FIG. 14, in a second, more complex mode of operation, data is collected from all four legs of a horse. Steps 150-154 are similar to steps 100-104 except that they are performed on data collected from all four legs. In step 156 curves or plots similar to the ones in FIGS. 7-12. In step 158 references, threshold levels, standard curves and other similar information is collected. In step 160 the current traces and plots are compared to the references and thresholds from step 158. In step 162 the data bases are updated to include the data collected in step 154, and then in step 164 the data is displayed or otherwise conveyed to the users.

The apparatus and method has other possible uses in addition to diagnosing animal health. The system can provide direct, near real-time, feedback during training. Such feedback can be used to help establish and maintain a desired gait of these animals. For example, an unsaddled horse can be trotted around an enclosure and the acquired data set as a standard for that particular horse. A saddle can be added to the horse's back and the fit, weight or design of the saddle can be modified until the same trotted course matches as closely as possible, the initial data taken before saddling. In the same manner a reference can be set in the absence of a rider, so that the rider can learn to adjust his behavior to produce optimum movement by the horse. The methods used here to characterize a specific gait can also be used to predict future uses for a young horse, thus achieving better results.

Numerous modifications may be made to the invention without departing from its scope as defined in the appended claims.

We claim:

1. An apparatus for evaluating an animal with several limbs, comprising:
a sensor attached to a non-impact surface of a limb and generating sensing signals indicative of the limb's contact with the ground due to physical movement; and
a control unit receiving said sensing signals and generating an indication of one of a state and characteristic of the animal based on said sensing signals.

2. The apparatus of claim 1 wherein said sensor is adapted to generate said signals in accordance with mechanical activity in the bone caused by said contact.

3. The apparatus of claim 2 wherein said sensor generates signals indicative of one of stress, temperature, vibration and acceleration.

4. The apparatus of claim 1 wherein said sensor is attached to the hoof wall.

5. The apparatus of claim 1 wherein said sensing signals are transmitted wirelessly to said control unit.

6. The apparatus of claim 1 wherein said sensing signals are transmitted by wire to said control unit.

7. The apparatus of claim 1 wherein said control unit is attached to the animal.

8. The apparatus of claim 1 wherein said control unit is remote from said animal.

9. An apparatus for evaluating an animal comprising:
a sensor attached to at a limb of an animal and generating signals indicating data generated in the limb resulting from the physical movement of the limb as the animal is involved in physical motion;
a control unit receiving said signals and generating an indication of the physical state of the animal in accordance with said signals; and
a display showing said physical status.

10. The apparatus of claim 9 wherein said control unit generates a time-dependent trace composed of several segments, each segment corresponding a step phase, said trace being shown on said display.

11. The apparatus of claim 10 wherein said control unit generates said trace with said trace having several consecutive portions, each portion corresponding to a component of the limb's physical movement in a stride.

12. The apparatus of claim 9 wherein said display indicates information descriptive of lameness of the animal.

13. The apparatus of claim 9 wherein said display indicates information descriptive of the performance of the animal.

14. The apparatus of claim 9 further comprising several sensors, each sensor being attached to a respective limb, and wherein said control unit generates a plot having several axes and sectors, each axis corresponding one of the limbs.

15. The apparatus of claim 14, wherein said control unit generates an image element for each impact, said image element having an amplitude indicative of the magnitude of the impact and an angle indicative of the differential timing between the impacts of two limbs.

16. The apparatus of claim 9 wherein said controller generates said indication by comparing said signals to predetermined values.

17. A method of diagnosing an animal by its gait, comprising the steps of:
attaching a sensor to a limb of the animal;
sensing forces generated in the limb by impact on the ground due to physical movement; and
analyzing said forces.

18. The method of claim 17 wherein said analyzing includes generating a time-dependant traces of said signals.

19. The method of claim 17, further comprising comparing characteristics several limbs to each other.

20. The method of claim 17 wherein said analyzing includes generating a plot of a plurality of signals along a plurality of axes and sectors, each axis corresponding to a limb.
